(19) United States
(12) Patent Application Publication
(10) Pub. No.: US 2023/0289771 A1
(43) Pub. Date: Sep. 14, 2023

(54) ATHLETE NAME, IMAGE, AND LIKENESS MARKETING AND DIRECT PAYMENT SYSTEM

(71) Applicant: Brent Russell Chapman, Frisco, TX (US)

(72) Inventor: Brent Russell Chapman, Frisco, TX (US)

(21) Appl. No.: 18/120,351

(22) Filed: Mar. 10, 2023

Related U.S. Application Data
(60) Provisional application No. 63/319,718, filed on Mar. 14, 2022.

(51) Int. Cl. G06Q 20/32; G06Q 20/40; G06Q 30/08; G06Q 20/10; G06Q 20/36

(52) U.S. Cl. CPC G06Q 20/3265; G06Q 20/3267; G06Q 20/4014; G06Q 30/08; G06Q 20/10; G06Q 20/3672; G06Q 2220/00

(57) ABSTRACT

An athlete name, image, and likeness (NIL) marketing and direct payment system is disclosed. The athlete NIL marketing and direct payment system supports a marketplace which enables people to send money to athletes for their name, image, likeness (NIL). The athlete NIL marketing and direct payment system supports ownership NFT tokens for the athlete's NIL on the blockchain as well as a sales and marketing platform that allows for direct payment from people to the athletes.

### CLAIM OF PRIORITY

This application is a conversion application of, and claims priority to, U.S. Provisional Patent Application No. 63/319,718 titled ATHLETE NAME, IMAGE, AND LIKENESS MARKETING AND DIRECT PAYMENT SYSTEM filed on Mar. 14, 2022. The contents of the aforementioned applications are incorporated herein by reference in entirety thereof.

### FIELD OF TECHNOLOGY

Disclosed is a method and/or system related generally to communication and payment systems, and more particularly, to an athlete name, image, and likeness (NIL) marketing and direct payment system.

### BACKGROUND

Many athletes earn no compensation for playing their sport, yet have a loyal fan base. For example, high school athletes and college athletes often do not earn money from playing their sport. However these same athletes can have a celebratory status—drawing audiences to follow and watch their talent. Unfortunately, athletes have no centralized location to market their name, image or likeness for compensation. Additionally, fans and patrons do not have a means to directly fund athletes. There is no centralized marketplace for athletes to sell their name, image or likeness.

Therefore, what is needed is a centralized system that enables athletes to market their name, image, and/or likeness (NIL) and receive direct payments for the same.

### SUMMARY

Disclosed method and/or system related generally to communication and payment systems, and more particularly, to an athlete name, image, and likeness (NIL) marketing and direct payment system.

In one aspect, a novel athlete name, image, and likeness (NIL) marketing and direct payment system is disclosed. In some embodiments, the athlete NIL marketing and direct payment system offers an integrated solution for the athletes that encompasses non-fungible token (NFT) based on blockchain technology and a sales and marketing platform and marketplace which allows for direct payment from people to the athletes.

Another aspect of the invention include a novel athlete name, image, and likeness (NIL) marketing and direct payment system. In some embodiments, the athlete NIL marketing and direct payment system offers an integrated solution for the athletes that encompasses non-fungible token (NFT) based on blockchain technology and a sales and marketing platform and marketplace which allows for direct payment from people to the athletes.

As stated above, not all athletes have the opportunity to obtain compensation for their name, image or likeness. Additionally, people do not have a means to directly fund athletes. There is no centralized marketplace for athletes to sell their name, image or likeness. Embodiments of the athlete NIL marketing and direct payment system described in this specification solve such problems by way of a digital, systemic, real-time application (both mobile and web-based) for people to pay athletes for their name, image, and likeness, where ownership is recorded and authenticity and uniqueness is guaranteed using non-fungible token (NFT) blockchain technology. Athletes can market their name, image, likeness (NIL) directly and share it on social media

Further aspects of the athlete NIL marketing and direct payment system described in this specification differ from and improve upon currently existing options. In particular, some embodiments differ by providing a unified process that revolutionizes the current marketplace where the creating, marketing, and payment functions are disunited. Additionally, the process provided via the athlete NIL marketing and direct payment system places the athlete in control of the monetization of their own name, image, and likeness. This creates a centralized marketplace allowing for commodification of the athlete's name, image, and likeness.

In addition, there is presently nothing like the athlete NIL marketing and direct payment system in the marketplace today. The unified process offered by way of the athlete NIL marketing and direct payment system revolutionizes the current marketplace where the creating, marketing, and payment functions are disunited. Additionally, the athlete NIL marketing and direct payment system places the athlete in control of the monetization of their own name, image, and likeness.

Currently, nothing exists to solve the problems noted above and no other concept or technology presently supports the functions and aspects of the athlete NIL marketing and direct payment system described in this specification. Specifically, the athlete NIL marketing and direct payment system offers an integrated solution for the athletes that encompasses the blockchain technology and a sales and marketing platform in one and allows for direct payment from people to the athletes.

The athlete NIL marketing and direct payment system of the present disclosure may be comprised of the following elements. This list of possible constituent elements is intended to be exemplary only and it is not intended that this list be used to limit the athlete NIL marketing and direct payment system of the present application to just these elements. Persons having ordinary skill in the art relevant to the present disclosure may understand there to be equivalent elements that may be substituted within the present disclosure without changing the essential function or operation of the athlete NIL marketing and direct payment system.

The methods and systems disclosed herein may be implemented in any means for achieving various aspects, and may be executed in various forms, when executed by a machine, cause the machine to perform any of the operations disclosed herein. Other features will be apparent from the accompanying drawings and from the detailed description that follows.

### BRIEF DESCRIPTION OF THE DRAWING

The embodiments of this invention are illustrated by way of example and not limitation in the figures of the accompanying drawings, in which like references indicate similar elements and in which:

FIG. 1 illustrates a schematic block diagram of the direct payment system, according to one embodiment.

FIG. 2 illustrates a process flow diagram detailing the operations involved in the direct payment system, according to one embodiment.

Other features of the present embodiments will be apparent from the accompanying drawings and from the detailed description that follows.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

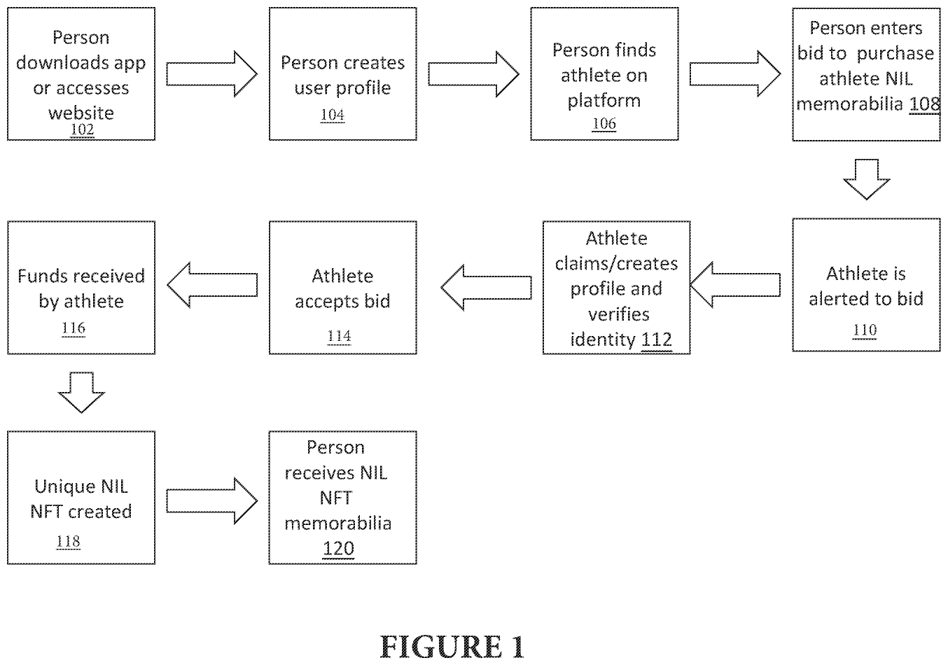

FIG. 1 illustrates a schematic block diagram of the direct payment system, according to one embodiment. In process 102, person downloads the app from their mobile phone app store or accesses the myNILpay website.

In process 104, person creates a myNILpay user profile.

In process 106, person finds athlete on the myNILpay platform.

In process 108, person enters a bid to purchase a non-fungible token (NFT) or other memorabilia of your selected athletes name, image, likeness (NIL).

In process 110, athlete is alerted of the bid.

In process 112, athlete creates or claims their athlete profile and verifies their identity.

In process 114, the athlete accepts or declines the bid.

In process 116, if accepted by the athlete, the funds are received by the athlete.

In process 118, Unique non-fungible token (NFT) or other memorabilia featuring athlete name, image, likeness (NIL) is created.

In process 120, Person receives the non-fungible token (NFT) or other memorabilia featuring athlete name, image, likeness (NIL).

The various elements of the athlete NIL marketing and direct payment system of the present disclosure may be related in the following exemplary fashion. It is not intended to limit the scope or nature of the relationships between the various elements and the following examples are presented as illustrative examples only. Steps 102, 104, 106, 108, and 112 describe the initial account creation or claim process (Part 1), which each athlete needs to complete only 1 time. Steps 110, 114, 116, 118, and 120 describe the steady state process where the athlete is using the platform (Part 2). Completion of Part 1 is necessary to proceed to Part 2. Part 2 encompasses automatic production of unique name, image, likeness (NIL) non-fungible tokens (NFT), athlete memorabilia, social media promotion and interaction, and purchase and sale of name, image, likeness (NIL) non-fungible tokens (NFT).

The athlete NIL marketing and direct payment system of the present disclosure generally works by following the above listed steps, in the order listed. This will allow an athlete to market his or her name, image, and likeness (NIL) as a non-fungible token (NFT) to all users of the app and receive payment for same.

Starting with steps 102, 104, 106, 108, and 112 (or “Part 1”), the person triggers a series of logical steps to contact the student athlete and prompt the athlete to claim their account and confirm their identity. Once Part 1 is completed, the athlete has an active account in the athlete NIL marketing and direct payment system, and their identity has been confirmed. Part 1 confirms market interest in the athlete's name, image, likeness (NIL) as a non-fungible token (NFT), and confirms that the individual accesses the athlete NIL marketing and direct payment system to provide the name, image, likeness (NIL) is in fact the person whose name, image, likeness (NIL) is being used in the non-fungible token (NFT).

Next, steps 110, 114, 116, 118, and 120 (or “Part 2”) involves an ongoing process whereby athletes and people continue to use the athlete NIL marketing and direct payment system. This includes the logical steps necessary to create a unique item for the NFT based on the athlete's submitted content and register it on the blockchain. Part 2 also includes payment and provision for sharing on social media

To make the athlete NIL marketing and direct payment system of the present disclosure, one would code and deploy the athlete NIL marketing and direct payment system and provide the infrastructure, digital media files, blockchain, cloud computing resources, and mobile and web-based applications. These resources are used to create a practical implementation of the process carried out in connection with the athlete NIL marketing and direct payment system

To use the athlete NIL marketing and direct payment system of the present disclosure, contributors and athletes can engage in commerce for non-fungible tokens (NFT) and memorabilia featuring the athlete's name, image, likeness (NIL).

Additionally, the athlete NIL marketing and direct payment system can be adapted for use in other fields of technology through artificial intelligence, machine learning, and other means of data analytics.

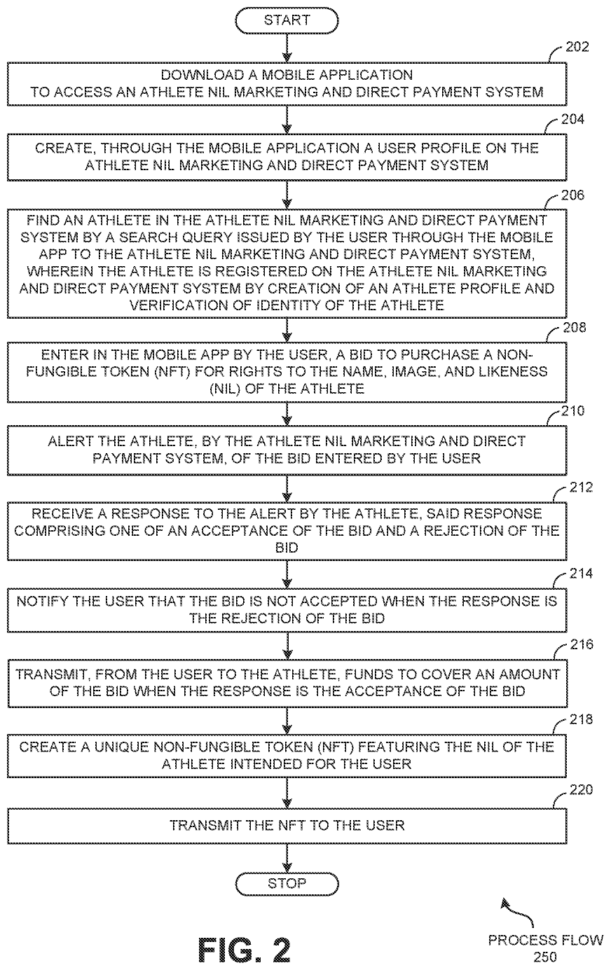

FIG. 2 illustrates a process flow 250 diagram detailing the operations involved in the direct payment system, according to one embodiment.

In operation 202, a user may download a mobile application to access an athlete NIL marketing and direct payment system. In operation 204, the user may create, through the mobile application a user profile on the athlete NIL marketing and direct payment system.

In operation 206, the user may find an athlete in the athlete NIL marketing and direct payment system by a search query issued by the user through the mobile app to the athlete NIL marketing and direct payment system, wherein the athlete is registered on the athlete NIL marketing and direct payment system by creation of an athlete profile and verification of identity of the athlete.

In operation 208, the user may enter a bid to purchase a non-fungible token (NFT) for rights to the name, image, and likeness (NIL) of the athlete. In operation 210, the system may alert the athlete, by the athlete NIL marketing and direct payment system, of the bid entered by the user. In operation 212, the system may receive a response to the alert by the athlete, said response comprising one of an acceptance of the bid and a rejection of the bid.

In operation 214, the system may notify the user that the bid is not accepted when the response is the rejection of the bid. In operation 216, the system may transmit, from the user to the athlete, funds to cover an amount of the bid when the response is the acceptance of the bid. In operation 218, the system may create a unique non-fungible token (NFT) featuring the NIL of the athlete intended for the user. In operation 220, the system may transmit the NFT to the user.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention.

1. A method comprising:
providing a mobile app to access an athlete name, image, and likeness (NIL) marketing and direct payment system;
creating, through the mobile app by the user, a user profile on the athlete NIL marketing and direct payment system;
finding an athlete in the athlete NIL marketing and direct payment system by a search query issued by the user through the mobile app to the athlete NIL marketing and direct payment system, wherein the athlete is registered on the athlete NIL marketing and direct payment system by creation of an athlete profile and verification of identity of the athlete;
entering, in the mobile app by the user, a bid to purchase a non-fungible token (NFT) for rights to the name, image, and likeness (NIL) of the athlete;
alerting the athlete, by the athlete NIL marketing and direct payment system, of the bid entered by the user;
receiving a response to the alert by the athlete, said response comprising one of an acceptance of the bid and a rejection of the bid;
notifying the user that the bid is not accepted when the response is the rejection of the bid;
transmitting, from the user to the athlete, funds to cover an amount of the bid when the response is the acceptance of the bid;
creating a unique non-fungible token (NFT) featuring the NIL of the athlete intended for the user; and
transmitting the NFT to the user.

2. The method of claim 1, wherein an automated recommendation engine is utilized to recommend athletes that the user is able to follow and sponsor based on interest.

3. The method of claim 1 wherein the user is able to watch live-sporting events of the athlete through a centralized profile, and wherein a schedule of the athlete's future games, statistics, and upcoming events is visible through the mobile app.

4. The method of claim 1 wherein an artificial intelligence based system is employed to automatically train a dataset of statistics and recommend to the user athletes they may be able to sponsor with similar attributes.
